(19) United States
(12) Patent Application Publication
(10) Pub. No.: US 2025/0365053 A1
(43) Pub. Date: Nov. 27, 2025

(54) PREDICTIVE TRACKING FOR ANTENNA SWITCHING AND BEAM SWITCHING IN EXTENDED REALITY

(71) Applicant: QUALCOMM Incorporated, San Diego, CA (US)

(72) Inventors: Akash KUMAR, Hyderabad (IN); Eswara Venkata Narasimha Muthyala Prasad BAHADURSHA, Hyderabad (IN); Raveesh JUNEJA, Hyderabad (IN)

(21) Appl. No.: 18/670,434

(22) Filed: May 21, 2024

(51) Int. Cl. H04B 7/06; H04W 24/02; H04W 64/00

(52) U.S. Cl. CPC H04B 7/0695; H04W 24/02; H04W 64/006

(57) ABSTRACT

Certain aspects of the present disclosure provide techniques for predictive tracking for antenna switching and beam switching in extended reality. A method for wireless communication by a user equipment (UE) includes collecting data using one or more sensors; predicting a future orientation and position of the UE based on the collected data; preparing a configuration of the UE for at least one of antenna switching or beam switching in response to the predicted future orientation and position of the UE; and performing the at least one of the antenna switching or beam switching, using the prepared configuration of the UE, in response to a detected current orientation and position of the UE.

### FIELD OF THE DISCLOSURE

Aspects of the present disclosure relate to wireless communications, and more particularly, to techniques for antenna switching and beam switching.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a user equipment (UE). The method includes collecting data using one or more sensors; predicting a future orientation and position of the UE based on the collected data; preparing a configuration of the UE for at least one of antenna switching or beam switching in response to the predicted future orientation and position of the UE; and performing the at least one of the antenna switching or beam switching, using the prepared configuration of the UE, in response to a detected current orientation and position of the UE.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example extended reality (XR) display using inertial measurement units (IMU) sensors and electromyography (EMG) sensors for predictive tracking.

FIG. 6 is an example antenna switch diversity (ASDIV) algorithm timeline.

FIGS. 7A and 7B illustrate an example TX AGC per slot timeline.

FIG. 8 illustrates an example beam switching timeline.

FIG. 9 is a call flow diagram depicting example operations between a UE and a network entity for antenna switching and beam switching with predictive tracking.

FIG. 10 depicts a method for wireless communications.

FIG. 11 depicts aspects of an example communications device.

### DETAILED DESCRIPTION

Aspects of the present disclosure provide apparatuses, methods, processing systems, and computer-readable mediums for antenna switching and beam switching with predictive tracking.

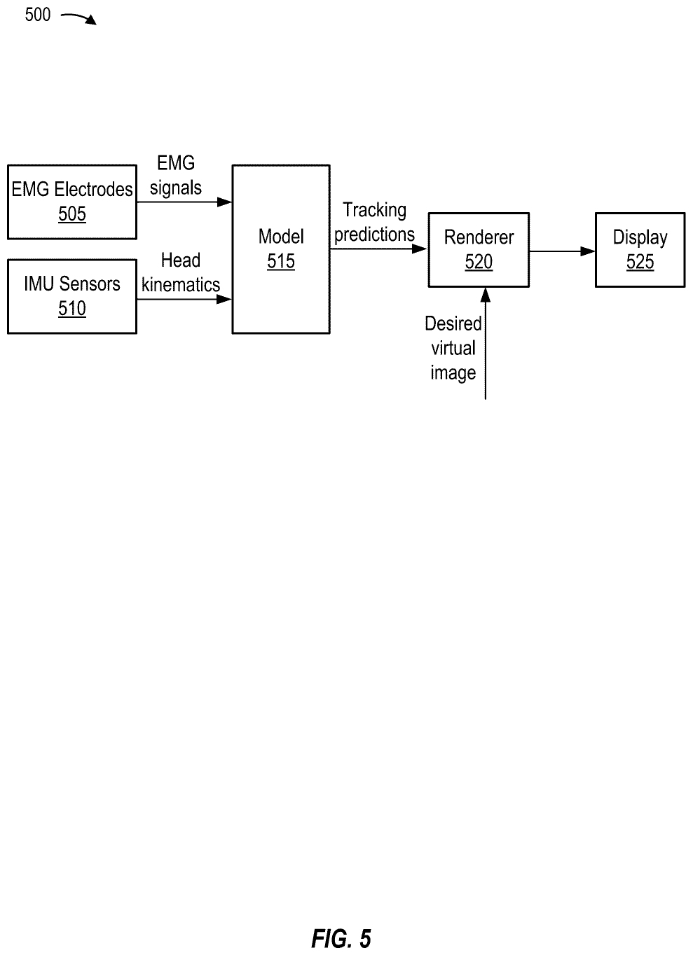

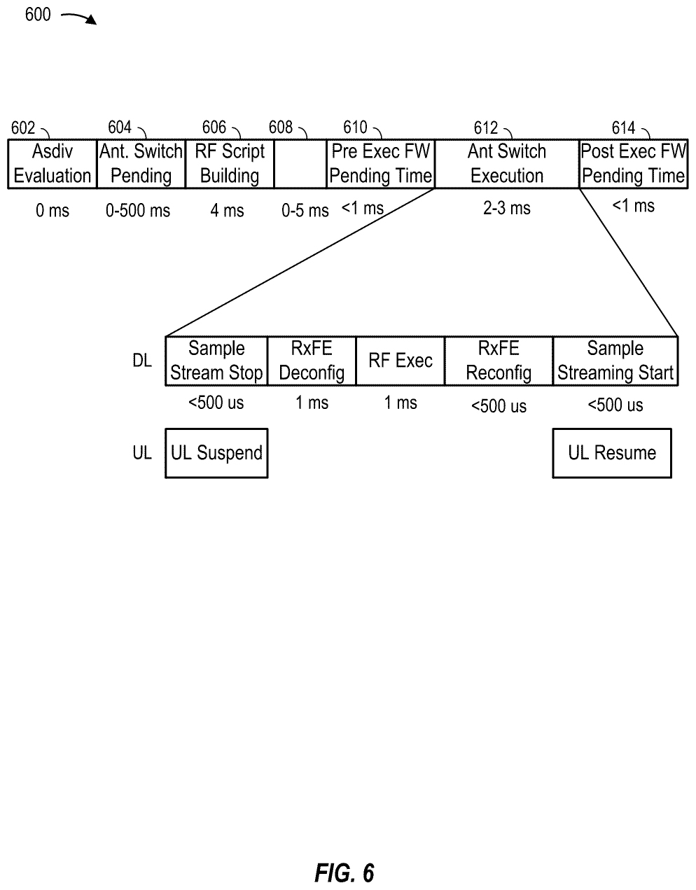

As discussed in more detail herein with respect to FIG. 5, extended reality (XR) technologies may require low latency and high reliability to provide an immersive user experience. In particular, a low motion to photon latency is desirable for the XR uses cases. Further, as discussed in more detail herein with respect to FIGS. 6-8, current antenna switching and beam switching techniques may not provide sufficiently low latencies for XR use cases, for example, leading to higher MTP latencies and long blanking times.

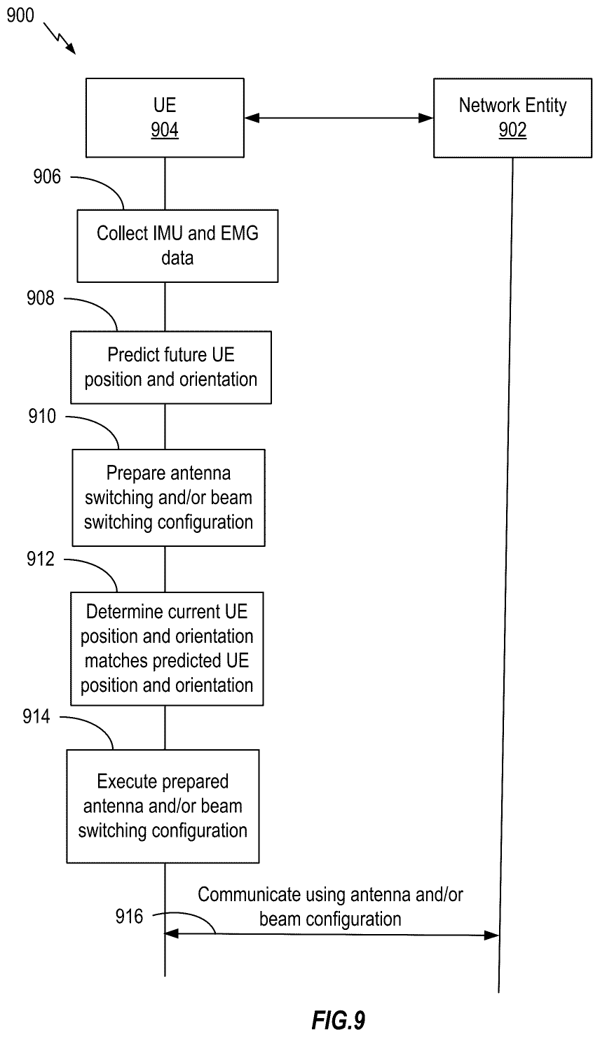

As discussed in more detail herein with respect to FIGS. 9-11, aspects of the present disclosure provide for use of predictive tracking, in particular predictive tracking using inertial measurement unit (IMU) and electromyography (EMG) sensor data, to predict future position and orientation of a user equipment (UE) and, based on the predicted future position and orientation of the UE prepare an antenna switching configuration and/or a beam switching configuration. For example, the UE may initiate preparation of the configuration earlier than in current approaches which may be reactive to current measurements such as received signal strength indicator (RSSI) and/or signal to noise ratio (SNR) measurements. Thus, when the UE determines a current UE position and orientation that matches (or is close to, such as within a prespecified range of) the predicted UE position and orientation, the UE can execute the prepared antenna switching configuration and/or the prepared beam switching configuration, thereby reducing the latency of the antenna or beam switch, in turn leading to lower MTP and shorter blanking times.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

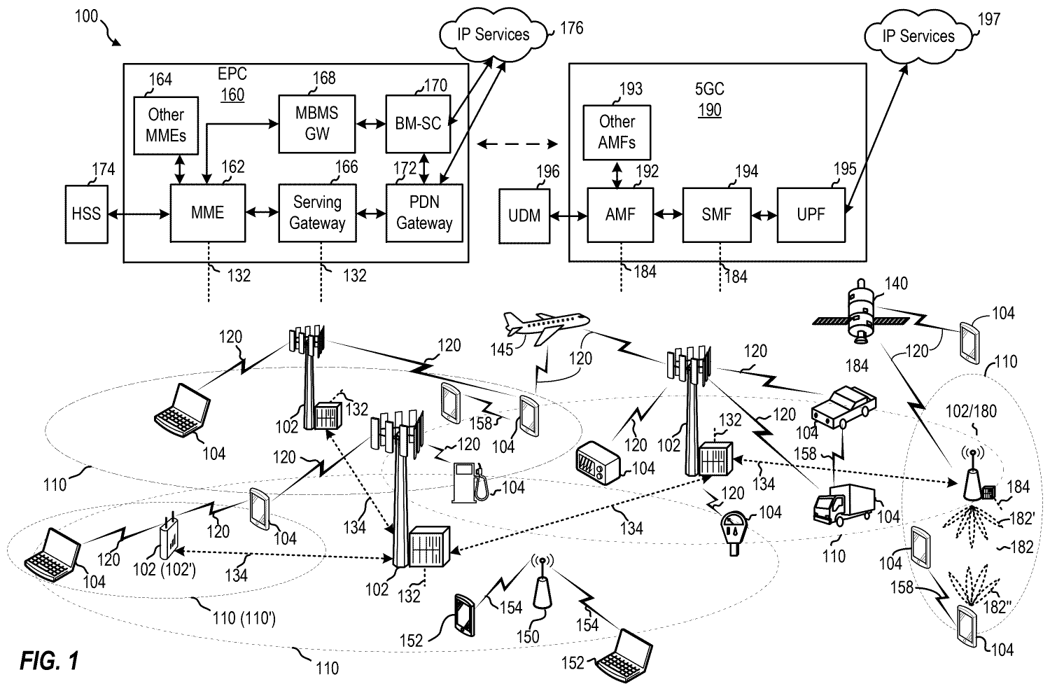

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

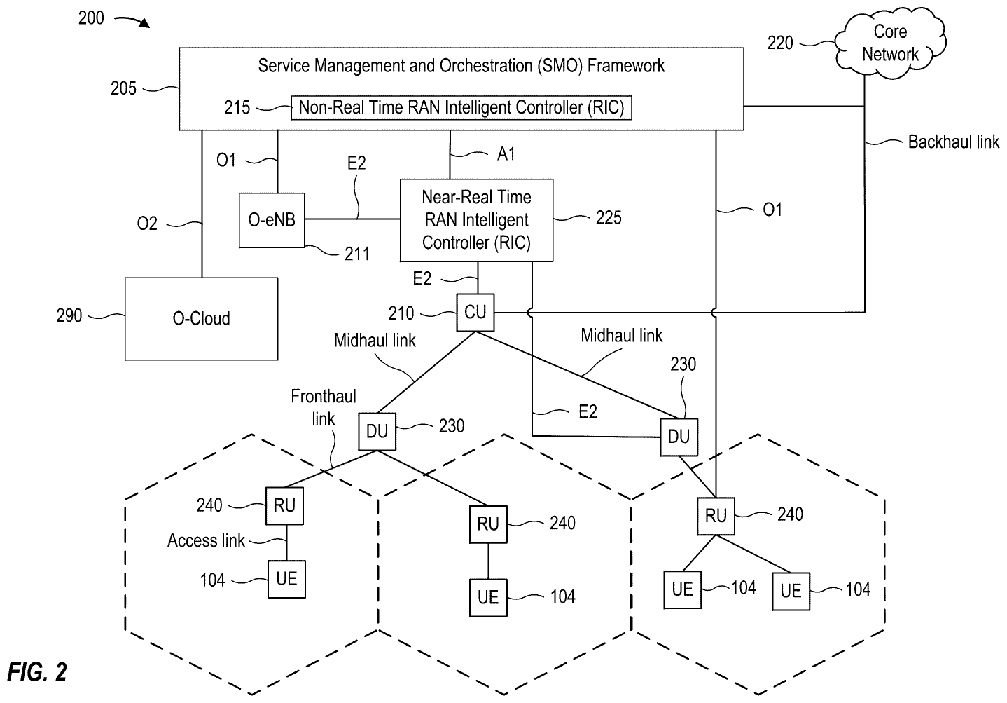

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHZ, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′ BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

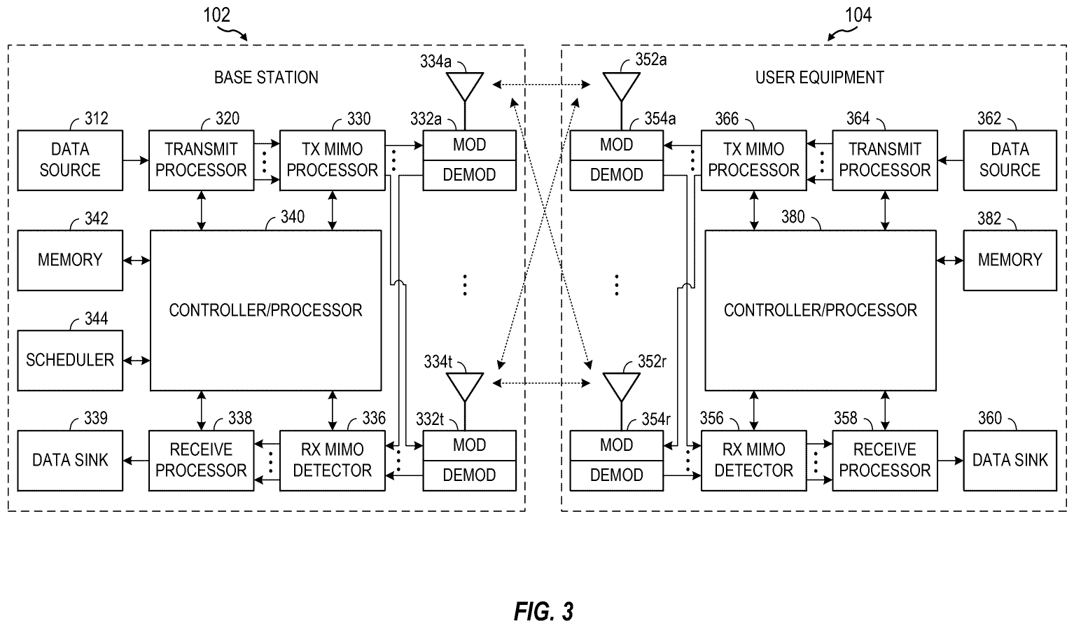

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

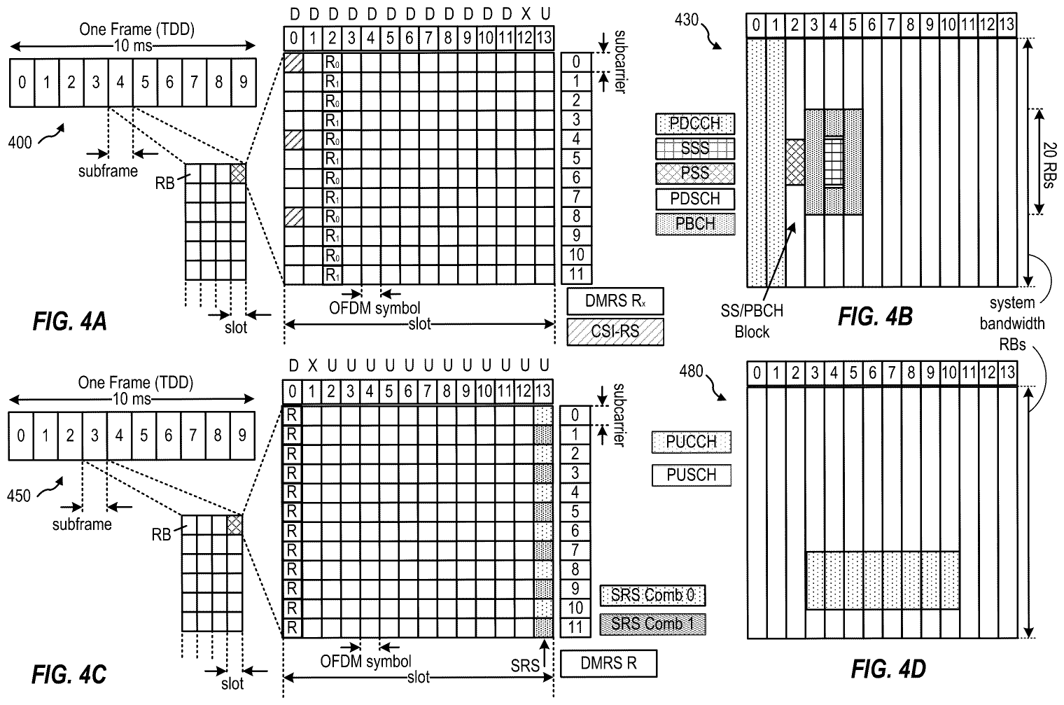

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 24× 15 kHz, where u is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Extended Reality

Extended Reality (XR) is an umbrella term encompassing various immersive technologies, including virtual reality (VR), augmented reality (AR), and mixed reality (MR). These technologies blend the physical and digital worlds, offering users interactive and immersive experiences. XR has garnered significant interest across industries, from entertainment and gaming to healthcare, education, and manufacturing. XR presents opportunities for enhanced communication experiences and services leveraging mobile networks, such as Wi-Fi broadband and NR/LTE.

XR technologies rely on a combination of hardware and software to create immersive environments. Virtual reality (VR) involves users being fully immersed in a digital environment through head mounted displays (HMD), such as headsets, goggles, or smart eye glasses, that replace their real-world surroundings with virtual ones. Augmented reality (AR), on the other hand, overlays digital content onto the real world, typically viewed through devices such as smartphones or smart glasses. Mixed reality (MR) combines elements of both VR and AR, allowing digital objects to interact with the physical environment in real-time.

XR applications require high-speed, low-latency connections to deliver smooth and immersive experiences. 3GPP standards, such as those related to 5G (the fifth generation of mobile networks), provide the necessary framework for delivering high-bandwidth, low-latency connectivity essential for XR applications. Features like enhanced Mobile Broadband (eMBB), Ultra-Reliable Low Latency Communication (URLLC), and Network Slicing enable mobile networks to meet the demanding requirements of XR applications.

Security and privacy are also critical considerations in XR applications, particularly when transmitting sensitive personal or corporate data over mobile networks. 3GPP standards incorporate robust security mechanisms, including authentication, encryption, and access control, to protect XR users' data and privacy.

Furthermore, 3GPP standards facilitate interoperability between XR devices and networks from different vendors. This interoperability is essential for creating a seamless XR ecosystem where users can access content and services across various platforms and devices.

For providing XR experiences that make the user feel immersed and present, factors that provide a quality user experience include a high level degree of freedom (e.g., 6DoF), accuracy while tracking users head in rotational and translational movements, low motion to photon (MTP) latency (e.g., a time gap between a time when the user moves their head to a time when the user sees the display change), low persistence or higher refresh rate, higher resolution, and wide field of view. To address these requirements, 3GPP has created quality of service (QOS) metrics for services, for example, in 3GPP TS 23.501, Table 4.3.3-1 3GPP provides a table mapping 5QI to QoS characteristics include resource type, default priority level, packet delay budget (PDB), packet error rate (PER), default maximum data burst volume (MDBV), and default averaging window. Different types of XR experiences may have varying QoS requirements, depending on factors like resolution, frame rate, and interactivity. 3GPP standards define mechanisms for prioritizing XR traffic, ensuring that users receive consistent and reliable performance even in crowded network environments. PDB defines an upper bound for the round-trip time that a packet data unit (PDU) may be delayed between the UE and the XR server termination point. PER defines an upper bound for the rate of PDU (e.g. set of IP packets constituting a PDU) that have been processed by the sender of a link layer protocol (e.g. radio link control (RLC) protocol in RAN of a 3GPP access) but where all of the PDUs in the PDU-Set are not successfully delivered by the corresponding receiver to the upper layer (e.g. packet data convergence protocol (PDCP) in RAN of a 3GPP access).

Motion to photon (MTP) latencies exceeding one or more specified thresholds can not only degrade the user XR experience but also can cause several negative effects such as motion sickness due to higher MTP latencies.

### Aspects Related to Predictive Tracking

To help meet the tight timelines required for XR services, one solution to reducing MTP latency is the use of head movement predictions, referred to as predictive tracking. Various predictive tracking techniques, using various tracking sensors, may be used for predictive tracking.

This head movement prediction can be developed using various types of sensors and algorithms, such as using different types of predictive filter algorithms.

One example technique is Kalman predictive tracking, also known as Kalman filtering or simply Kalman tracking. Kalman tracking is a mathematical algorithm used for estimating the state of a dynamic system in the presence of uncertain or noisy measurements. The basic idea behind a Kalman filter is to combine information from a series of measurements and predictions to produce a more accurate estimate of the system's state. The Kalman filter operates recursively, meaning that it updates its estimate as new measurements become available. The algorithm is particularly effective in situations where there is uncertainty in both the measurements and the dynamics of the system being tracked.

Kalman filtering involves two main steps: prediction and update. In the prediction step, the Kalman filter uses a mathematical model of the system to predict its state at the next time step. This prediction is based on the system's current state and dynamics, as well as any control inputs (if applicable). The prediction also includes an estimate of the uncertainty associated with the prediction, often represented as a covariance matrix. In the update step, the Kalman filter combines the predicted state with the actual measurement obtained at the current time step. It calculates a correction factor, known as the Kalman gain, which determines how much weight to give to the prediction versus the measurement. The filter then updates its state estimate based on this correction, producing a more accurate estimate of the system's true state.

Another example technique is particle predictive tracking, also known as particle filtering or sequential Monte Carlo method. Particle predictive tracking is a probabilistic technique used for estimating the state of a dynamic system based on a series of noisy measurements. Particle predictive tracking may be particularly useful in situations where the system's dynamics are nonlinear or non-Gaussian, making traditional methods like the Kalman filter less effective.

In particle predictive tracking, the state of the system is represented by a set of particles, each of which represents a possible hypothesis about the true state of the system. These particles are randomly sampled from an initial state distribution and are propagated forward in time according to a dynamic model that describes how the system evolves over time. The dynamic model may be nonlinear and can capture complex behaviors such as acceleration or nonlinear motion. At each time step, the particles are updated based on new measurements obtained from sensors. This update step involves evaluating the likelihood of each particle given the measurement, which is calculated using a measurement model that describes the relationship between the true state of the system and the sensor measurements. The particles are then re-weighted based on their likelihood, with particles that are more consistent with the measurements receiving higher weights. After re-weighting, particles with low weights are discarded, and new particles are sampled from the remaining particles to maintain a constant population size. This process, known as resampling, helps prevent degeneracy, where all but a few particles have negligible weights, leading to poor estimation accuracy.

In some techniques, an inertial measurement unit (IMU) sensor and/or biomedical signals from electromyography sensors (EMG) may be used for predictive tracking. IMU sensors and EMG sensors provide valuable information about the motion of objects being tracked.

IMUs includes sensors such as accelerometers, gyroscopes, and magnetometers, which measure the linear acceleration, angular velocity, and magnetic field orientation of an object. Accelerometers measure the acceleration experienced by the object along its three orthogonal axes. By integrating acceleration over time, velocity and position can be estimated. Gyroscopes measure the rate of rotation around the three axes, providing information about the object's orientation and angular velocity. Magnetometers measure the strength and direction of the magnetic field, which can be used to determine the object's orientation with respect to the Earth's magnetic field. In predictive tracking, IMU data can be used to estimate the future trajectory of an object based on its current motion dynamics. This prediction can then be used to anticipate the object's future behavior and improve the accuracy of the tracking algorithm.

EMG sensor based prediction is based on the idea that there is a delay between human general action potential and muscle contraction or movements. EMG sensors measure the electrical signals generated by muscle contractions. These signals, known as electromyograms, provide information about the activity and intent of the muscles involved. In predictive tracking, EMG data can be used to infer the intended movements or actions of an individual based on their muscle activity. By analyzing patterns in the EMG signals, the user's intent can be decoded and used to predict their future movements or actions.

Further, by combining data from IMUs and EMG sensors, predictive tracking algorithms can leverage both the physical motion dynamics captured by IMUs and the user's intent inferred from EMG signals. This multi-modal approach enables more accurate and adaptive tracking of objects or individuals, particularly in dynamic and unpredictable environments. Additionally, the fusion of IMU and EMG data allows for the development of more intuitive and responsive tracking systems.

IMUs and EMGs may be used, for example together with predictive tracking algorithms, to predict aggressive movements with relatively low average error. FIG. 5 depicts an example system 500 for XR display using IMUs and EMGs for predictive tracking. As shown in FIG. 5, EMG electrodes 505 provide EMG signals to the predictive tracking model 515 and IMU sensors 510 may provide head kinematics to the predictive tracking model 515. The predictive tracking model 515 may predict information, such as future angular velocity and provide the predictive tracking information to the renderer 520. The renderer 520 may use desired virtual image information and the predictive tracking information to create the XR image and provide the XR image to the display 525. In some aspects, predictions may be made for 100-200 milliseconds into the future with a high degree of accuracy.

### Example Antenna Switching

Antenna switch diversity (ASDIV) is a technique used in wireless communication systems to improve the signal quality and reliability by dynamically switching between different antennas.

At the receiver side, ASDIV involves selecting the antenna with the best signal quality for reception. The switching can be based on various parameters such as signal strength, signal-to-noise ratio (SNR), or other quality metrics. By switching between antennas, ASDIV helps mitigate issues like fading, interference, and signal blockage, thereby enhancing the overall performance of the wireless communication system.

FIG. 6 is an example ASDIV algorithm timeline. During an ASDIV evaluation period 602 (e.g., 0 ms), evaluation processing may be performed every 640 ms. During an antenna switch pending period 604 (e.g., 0-500 ms), a pending ASDIV envelope (ENV) object to start ASDIV is used. During a radio frequency (RF) script building period 606 (e.g., 4 ms), with a start_cb, a TRM grant is started and RF script building is performed. During a gap 608 (e.g., 0-5 ms), once RF script building is complete, the execution time (exec_time) is calculated, the execution (EXEC) object is scheduled, and an FW command (cmd) for execution is sent. During a pre-execution FW pending time period 610 (e.g., <1 ms), RF/FW execution starts from a system configuration (SYS_CONFIG) sent time to the execution time. As shown in FIG. 6, the antenna switch execution period 612 (e.g., 2-3 ms), for downlink, includes a sample streaming stop period (e.g., <500 ms), an RxFE deconfiguration period (e.g., 1 ms), an RF execution period (e.g., 1 ms), an RxFE reconfiguration period (e.g., <199 ms), and a sample streaming start period (e.g., <500 ms). As shown in FIG. 6, the antenna switch execution period 612, for uplink, includes an UL suspend period and an uplink resume period after the RF/F execution is completed. During a post-execution FW pending time period 614 (e.g., <1 ms) begins from execution completion to confirmation received. After FW configuration is received, all objects may be descheduled.

The RF tune script, is a script or set of commands used to optimize and fine-tune RF parameters in the wireless devices. The RF tune scripts typically involve configuring various RF parameters such as transmission power levels (e.g., adjusting the transmit power to optimize coverage while minimizing interference and power consumption; antenna configuration (e.g., configuring antenna parameters such as tilt, azimuth, and mechanical downtilt to optimize coverage patterns and minimize interference); frequency planning (e.g., optimizing the allocation of frequencies to different cells or sectors within a network to minimize interference and maximize spectral efficiency); and other parameter. The specific contents and format of RF tune scripts can vary depending on the type of equipment or network technology being used and the requirements of the network operator. These scripts are typically executed using specialized network management tools or command-line interfaces provided by the equipment vendors or network operators.

The process of antenna switching involves routing the signal from one antenna to another based on certain criteria, such as signal strength or quality. ASDIV may use a cross switch (XSW) that is the component responsible for managing the signal routing process, ensuring that the signal is effectively switched between antennas to maintain optimal communication performance. The XSW plays a crucial role in the ASDIV functionality by enabling seamless transitions between antennas based on the prevailing network conditions. An antenna switching module (XSM) component controls the selection of antennas based on various criteria such as signal strength, signal quality, and interference levels. The ASM plays a vital role in implementing ASDIV by managing the switching between antennas to ensure the best possible reception quality and reliability for wireless communication devices.

Current ASDIV algorithms which are triggered based on effect, such as receive side received signal strength indicator (RSSI) and SNR. The periodicity of these measurements is tailored for slow moving scenario or linear movements and are not optimal for an XR device with high DOF movement. For example, the triggering may be delay intolerant and may result in higher blanking times for a single cycle of movement.

### Example Beam Switching

In certain systems, transmit automatic gain control (AGC) and beam switching may be used for optimize performance and efficiency, such as for massive multiple input multiple output (MIMO) technologies. Transmit (TX) AGC is a technique used to adjust the transmit power of signals based on real-time feedback from the receiver or environmental conditions to ensure reliable communication while minimizing interference and power consumption. The transmit power of signals needs to be adjusted dynamically to compensate for factors such as channel fading, path loss, and interference. Tx AGC continuously monitors these conditions and adjusts the transmit power accordingly to maintain a desired signal quality at the receiver.

Beam switching, also known as beam switching diversity, is a technique used in beamforming systems to improve coverage, capacity, and reliability by dynamically switching between different beamforming patterns or directions. Beamforming involves directing the transmission or reception of signals towards specific directions using phased array antennas. By adjusting the phase and amplitude of signals across multiple antenna elements, beamforming systems can create directional beams that focus energy towards desired locations, enhancing signal strength and reducing interference. Beam switching allows the system to adaptively select the best beamforming pattern based on changing channel conditions, user mobility, or traffic demands. By periodically evaluating the performance of different beams and switching to the most suitable one, beam switching optimizes the use of available resources and improves overall system efficiency.

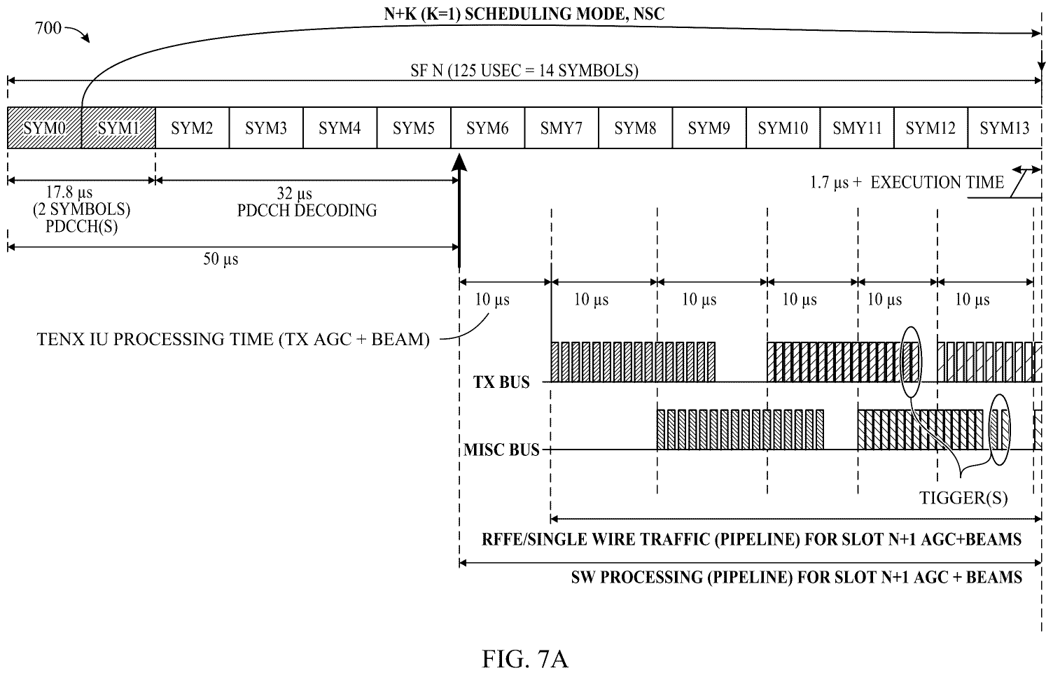

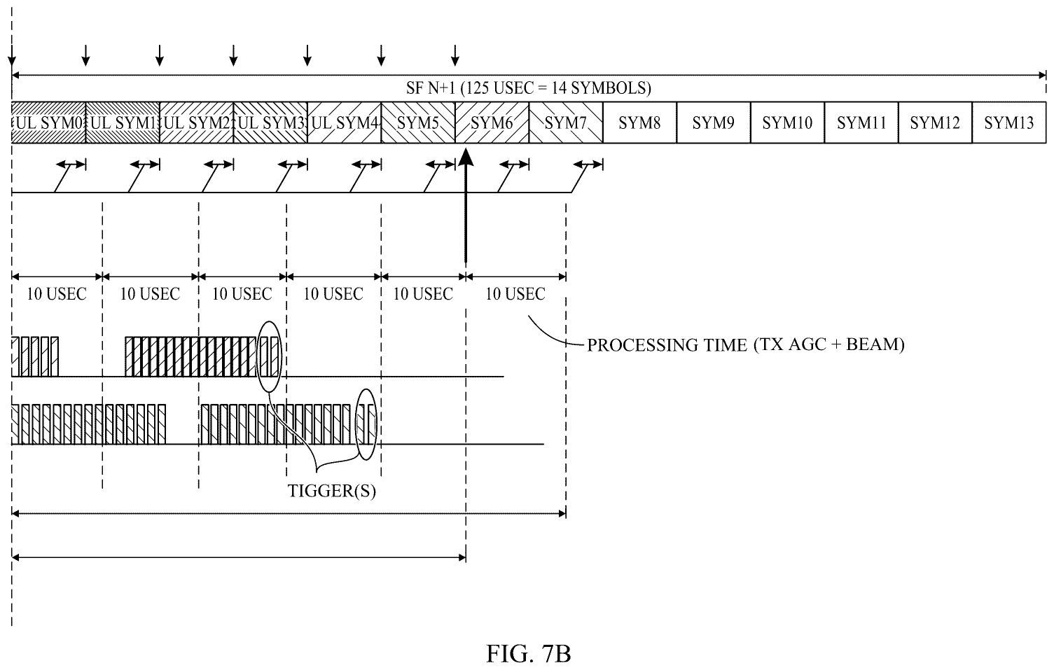

FIGS. 7A-7B illustrate an example TX AGC per slot timeline 700. In the example illustrated, one, two, or four SRS may be supported per slot. In some aspects, different TX AGC and/or different beams are used for UL demodulation reference signal (DMRS), physical uplink shared channel (PUSCH), and/or physical uplink control channel (PUCCH) transmissions.

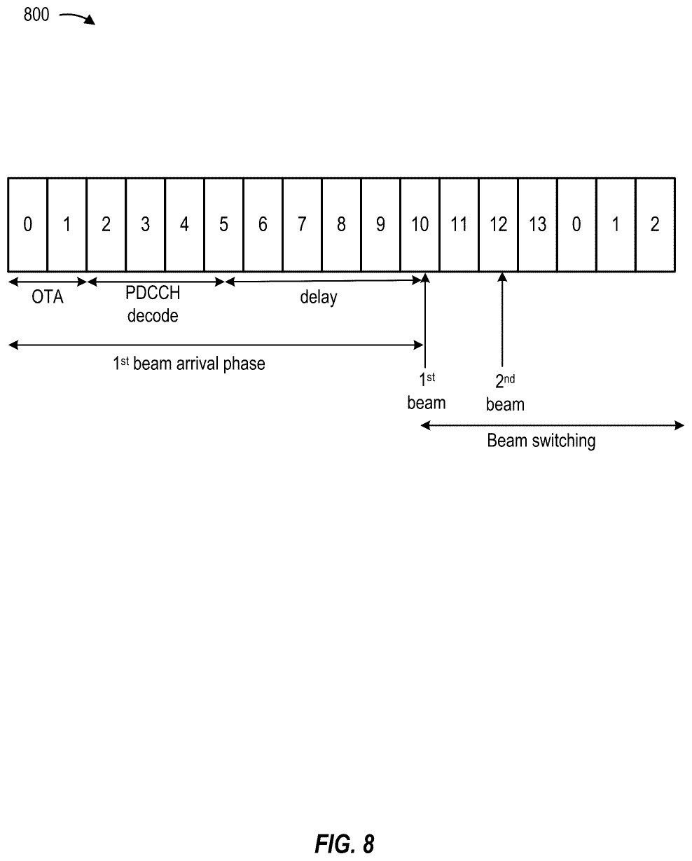

FIG. 8 illustrates an example beam switching timeline 800. As shown, two symbols (e.g., 0 and 1) may be used for over-the-air (OTA) signaling (e.g., 2*8.9 μs), three and a half symbols (e.g., 32 μs) may be used for PDCCH decoding, and there may be an approximately five symbol (e.g., 45.2 μs) delay including an RF switch (RFSW) delay (e.g., around 30 μs), an RF front end (RFFE) delay (e.g., around 13.5 μs), and a signal input/out (SIO) delay (e.g., around 1.7 μs), after which a first beam may be switched to a second beam (e.g., with a 1.51 symbol or 13.5 μs beam switch time for each beam switch). In the illustrated example, a slot length is 125 μs, a symbol length is 8.93 μs, the number of PDCCH symbols is 2, the PDCCH decoding time is 32 μs, the RFSW processing time is 30 μs, the RFFE and SIO transaction time is 15.21 μs, the first beam switch total time is 95.07 μs, the transaction time for each additional beam switch is 13.5 μs, a time per 32-bit write over the RFFE bus at 76 MHz is 0.9 μs, the time per 32-bit packet over SIO is 0.57 μs, the number of 32-bit writes per entry for codebook update is 0, the number of 32-bit writes for one beam trigger is 15, the overall time for one dynamic beam update is 15.21 μs, and the transaction time for each extra beam switch is 13.5 μs.

As described with respect to FIGS. 7-8, current beam switching algorithms are highly computationally intensive. In addition, beam switching algorithms require multiple neighbor beam measurements depending upon the predefined UE set of beams. During these scenarios, the UE may switch to wider beams before converging again to the narrow beams

### Example Antenna Switching and Beam Switching with Predictive Tracking

According to aspects of the present disclosure, predictive tracking information may be used to perform quicker antenna switching and/or beam switching. In some aspects, predictive tracking may be used to predict the position and orientation of a user equipment (e.g., a head mounted display) at a future time occasion (e.g., with a few hundreds of milliseconds). The predicted position and orientation of the UE may be used to perform pre-preparations for antenna switching and/or beam switching in order to reduce the latency. For example, the predicted position and orientation of the UE may be used to reduce the time for ASDIV or beam switching to perform the procedures more quickly than the approaches illustrated in FIGS. 6-8. In some aspects, use of the predicted position and orientation of the UE for antenna switching and/or beam switching may reduce UE blanking due to reconfiguration.

According to certain aspects, the predicted position and orientation of the UE are used for ASDIV. During aggressive movement scenarios (e.g., while a user is playing a game using a HMD), the orientation can change rapidly in a short span of time (e.g., within milliseconds). In this case, the serving primary Rx and Tx antennas may be out of the line of sigh (LOS) or may move in to a position with higher path loss. The predicted position and orientation of the UE may be used to predict the future antenna switching. In some aspects, the UE prebuilds the switching configurations offline to reduce the switching time and triggers the ASDIV switch, with a prebuilt configuration, based on an actual orientation matching a predicted orientation associated with the prebuilt configuration. This may reduce blanking time and latency, while maintaining a best path as primary Rx and Tx to increase reliability.

According to certain aspects, the UE may further predict a transmit power to use after the predicted antenna switch. In some systems, the UE estimates the initial TX power from the corresponding RX antenna path loss post each antenna switch, transmits with the same transmit power and further converges to the right TX power based on the network transmit power control indication (TPC). To do the estimation, close loop iterations between UE and base station may be performed to converge upon the final reliable UE transmit power. This may be detrimental in an XR scenario with aggressive movements because there is a possibility of the UE's transmit antenna getting switched frequently in a short span of time. According to certain aspects, the predicted position and orientation of the UE may be used to predict the best target transmit power for the predicted transmit antenna switch based on past data of reliable transmissions along the same orientation and antenna positions (e.g., assuming repetitive nature of movements in the XR scenario). This way, the UE can transmit with a reliable TX power right from when the antenna switch occurs.

According to certain aspects, the predicted position and orientation of the UE are used for beam switching. The predicted position and orientation of the UE may be used to predict the future beam switching. In some aspects, the UE prebuilds the switching configurations offline to reduce the switching time and triggers the beam switch, with a prebuilt configuration, based on an actual orientation matching a predicted orientation associated with the prebuilt configuration. In some aspects, the UE predicts the set of beams to the future time and prioritizes measurements on those set of beams.

According to certain aspects, to perform the antenna switching and/or beam switching using the predicted position and orientation of the UE, the UE may predict a position and orientation of the UE using one or more IMU and/or EMG sensors.

In some aspects, the UE sets a machine learning model predicted position and orientation error (Δθ) to a limit (X) and sets a future time (t) for which to predict the UE position and orientation. The UE may then optimize for the orientation error (Δθ) for the future time (t) to predict based on the use case (e.g., antenna switching and/or beam switching). As an example, for ASDIV, the UE may require t to be greater than a threshold value T, considering the switching and hardware processing time, and the UE may optimize for the orientation error (Δθ) for values of t greater than T. In some case, the future time is selected based on a worst case time (e.g., 500 μs). The UE may generate a final model with the optimized value for orientation error (Δθ). The final model may then be used for the predictive tracking to predict the UE orientation and position and the time t and make antenna switching and/or beam switching decisions based on the predictive tracking information.

The UE also incorporate UE performance indicators, such as block error rate (BLER) and/or SNR in the prediction and/or in the determination of whether to perform antenna switching and/or beam switching.

FIG. 9 depicts a process flow 900 for communications in a network between a network entity 902 and a user equipment (UE) 904. In some aspects, the network entity 902 may be an example of the BS 102 depicted and described with respect to FIGS. 1 and 3 or a disaggregated base station depicted and described with respect to FIG. 2. Similarly, the UE 904 may be an example of UE 104 depicted and described with respect to FIGS. 1 and 3. However, in other aspects, UE 904 may be another type of wireless communications device and network entity 902 may be another type of network entity or network node, such as those described herein.

According to certain aspects, the UE periodically determines the current and predicted UE position and orientation. In some aspects, the periodicity of the determination and prediction of the UE position and orientation may be selected dynamically by the UE or configured dynamically by the network.

As shown in FIG. 9, at operation 906, the UE 904 collects IMU and EMG sensor data and, at operation 908, the UE predicts the UE position and orientation at one or more future time occasions.

At operation 910, the UE prepares an antenna switching and/or beam switching configuration based on the predicted UE position and orientation. In some aspects, the UE identifies different sectors where the UE antenna and/or beam is serving based on the current UE position and orientation. For example, a two antenna UE may consider a 180 degree sector for each antenna, and four antenna UE may consider a 90 degree sector per antenna. In some aspects, if the UE 904 determines that the future predicted orientation and position of the UE falls within a sector for a different antenna, or different serving beam, than a currently used antenna or serving beam, the UE 904 may start preparing the RF tune script at operation 910.

At operation 912, the UE 904 determines a current UE position and orientation matches the predicted UE position and orientation and, at operation 914, executes the prepared antenna switching configuration and/or beam switching configuration. For antenna switching, the UE 904 toggles only the XSW keeping the other RF path constant. In some aspects, the UE 904 toggles the entire RF path which includes the XSW, the ASM, and the RF transceiver. In the next periodic check, if the UE 904 determines, at operation 912 that the current UE position and orientation shifts to the predicted sector threshold (or UE orientation falls within a buffer of that threshold, such as within −5 to +5 degrees of the threshold), the UE 904 can trigger, at operation 914, the EXEC handling to execute the switch and toggle the path to the new primary transmit antenna. For beam switching, once the current measured power values on the predicted beam is above the UE threshold, at operation 912, the UE 904 performs the beam switch by executing the prefetched RF tune scripts at operation 914.

At operation 916, the UE 904 communicates with the network entity 902 using the switched antenna configuration and/or beam configuration.

### Example Operations

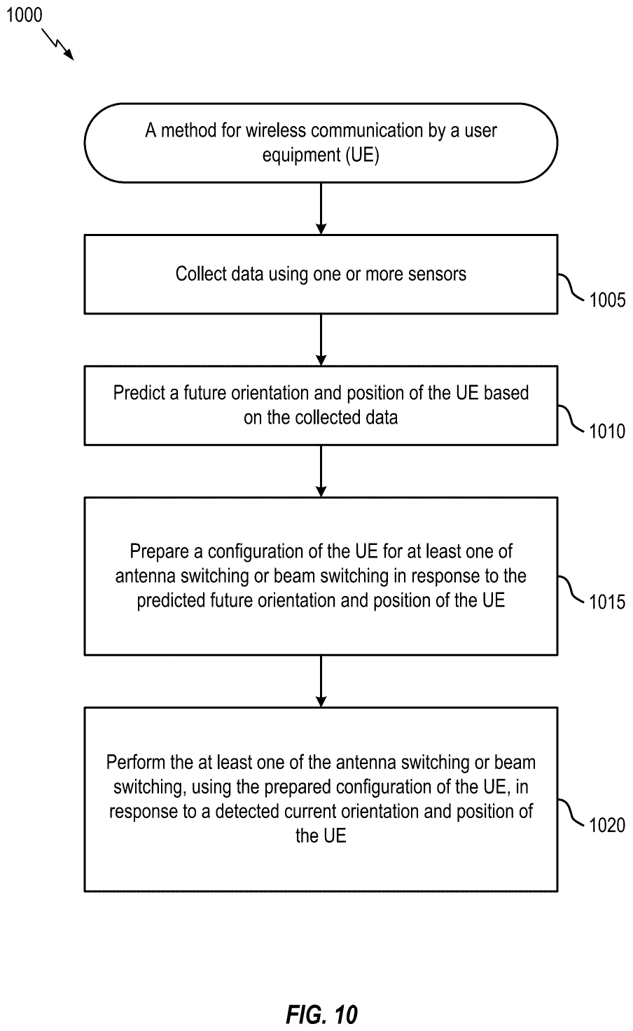

FIG. 10 shows an example of a method 1000 of wireless communication by a user equipment (UE), such as a UE 104 of FIGS. 1 and 3.

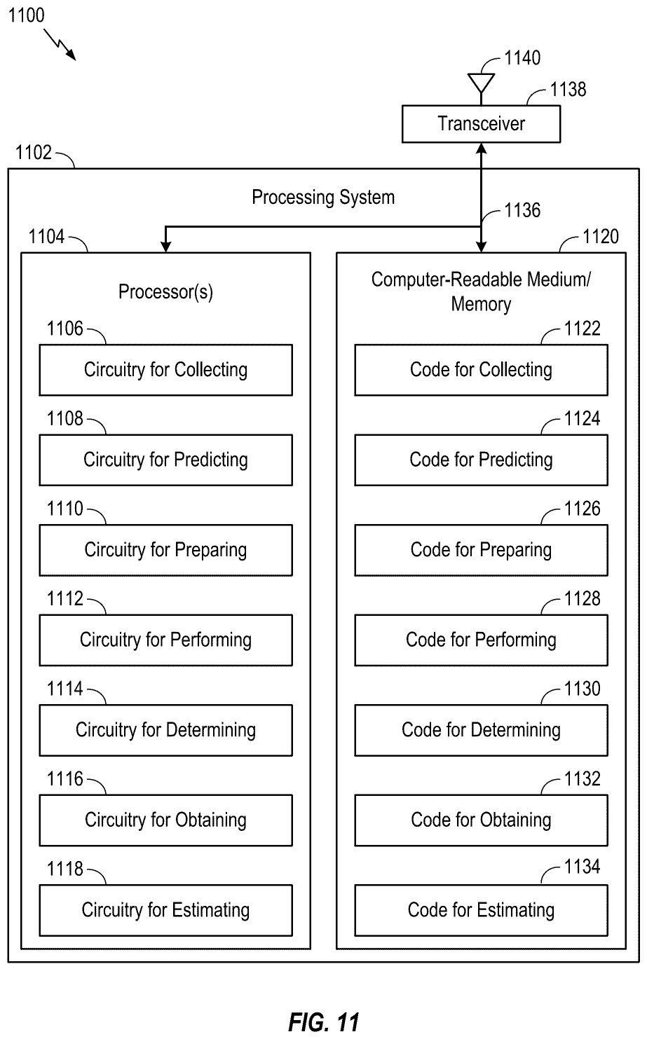

Method 1000 begins at step 1005 with collecting data using one or more sensors. In some cases, the operations of this step refer to, or may be performed by, circuitry for collecting and/or code for collecting as described with reference to FIG. 11.

Method 1000 then proceeds to step 1010 with predicting a future orientation and position of the UE based on the collected data. In some cases, the operations of this step refer to, or may be performed by, circuitry for predicting and/or code for predicting as described with reference to FIG. 11.

Method 1000 then proceeds to step 1015 with preparing a configuration of the UE for at least one of antenna switching or beam switching in response to the predicted future orientation and position of the UE. In some cases, the operations of this step refer to, or may be performed by, circuitry for preparing and/or code for preparing as described with reference to FIG. 11.

Method 1000 then proceeds to step 1020 with performing the at least one of the antenna switching or beam switching, using the prepared configuration of the UE, in response to a detected current orientation and position of the UE. In some cases, the operations of this step refer to, or may be performed by, circuitry for performing and/or code for performing as described with reference to FIG. 11.

In some aspects, the UE comprises an extended reality (XR) device.

In some aspects, the UE comprises an XR head mounted display, smart glasses, or other wearable XR device.

In some aspects, the collecting the data using the one or more sensors comprises collecting head tracking data of a user associated with the UE.

In some aspects, the one or more sensors comprise at least one of an inertial measurement unit (IMU), an electromyogram (EMG), or a combination thereof.

In some aspects, the predicting the future orientation and position of the UE based on the collected data comprises inputting the head tracking data of the user associated with the UE to a trained machine learning model to predict the future orientation and position of the UE.

In some aspects, the predicting the future orientation and position of the UE using the trained machine learning model comprises: setting one or more future times for orientation and position prediction for the machine learning model; optimizing an orientation and position prediction error limit, for the machine learning model, based on the one or more future times to generate a final machine learning model; and predicting the future orientation and position of the UE at the one or more future times using the final machine learning model.

In some aspects, the method 1000 further includes determining a future time for which to predict the future orientation and position of the UE, wherein the determining the future time is based on a worst case duration for executing a beam switch or antenna switch. In some cases, the operations of this step refer to, or may be performed by, circuitry for determining and/or code for determining as described with reference to FIG. 11.

In some aspects, the preparing the configuration of the UE for the antenna switching in response to the predicted future orientation and position of the UE comprises: periodically determining the current orientation and position of the UE; identifying, based on the current orientation and position of the UE, one or more sectors served by each of one or more antennas of the UE; and in response to identifying the predicted future orientation of the UE falls within a different sector than the one or more sectors, preparing a radio frequency (RF) tune script for the antenna switching.

In some aspects, performing the antenna switching comprises executing the RF tune script for the antenna switching.

In some aspects, the preparing the configuration of the UE for the antenna switching in response to the predicted future orientation and position of the UE comprises preparing for antenna switch diversity (ASDIV) switching based on the predicted future orientation of the UE.

In some aspects, the method 1000 further includes obtaining a plurality of predefined antenna switching configurations associated with a plurality of UE orientations and positions, wherein the preparing for the antenna switching in response to the predicted future orientation and position of the UE comprises preparing one of the plurality of predefined antenna switching configurations associated the predicted UE orientation and position. In some cases, the operations of this step refer to, or may be performed by, circuitry for obtaining and/or code for obtaining as described with reference to FIG. 11.

In some aspects, the preparing the configuration of the UE for the antenna switching in response to the predicted future orientation and position of the UE comprises preparing for the antenna switching before a measured signal quality meets an antenna switching trigger threshold.

In some aspects, the method 1000 further includes estimating an initial transmit power of the UE associated with prepared antenna switching, wherein the estimating the initial transmit power of the UE is before the performing the antenna switching. In some cases, the operations of this step refer to, or may be performed by, circuitry for estimating and/or code for estimating as described with reference to FIG. 11.

In some aspects, the estimating the initial transmit power of the UE based on the predicted future orientation of the UE comprises estimating the initial transmit power of the UE based on historical data of previous transmissions by the UE with the predicted orientation and position of the UE.

In some aspects, the preparing the configuration of the UE for the beam switching in response to the predicted future orientation and position of the UE comprises: periodically determining the current orientation and position of the UE; identifying, based on the current orientation and position of the UE, one or more sectors served by each of one or more antennas of the UE; and in response to identifying the predicted future orientation of the UE falls within a different sector than the one or more sectors, preparing a radio frequency (RF) tune script for the beam switching.

In some aspects, performing the beam switching comprises executing the RF tune scrip for the beam switching in response to a measured signal quality of candidate beam satisfying the beam switching threshold.

In some aspects, the method 1000 further includes obtaining a plurality of predefined beam switching configurations associated with a plurality of UE orientations and positions, wherein the preparing for the beam switching in response to the predicted future orientation and position of the UE comprises preparing one of the plurality of predefined beam switching configurations associated the predicted UE orientation and position. In some cases, the operations of this step refer to, or may be performed by, circuitry for obtaining and/or code for obtaining as described with reference to FIG. 11.

In some aspects, the preparing the configuration of the UE for the beam switching in response to the predicted future orientation and position of the UE comprises: predicting a set of future candidate beams based on the predicted future orientation and position of the UE; and prioritizing measurements on the predicted set of future candidate beams.

In one aspect, method 1000, or any aspect related to it, may be performed by an apparatus, such as communications device 1100 of FIG. 11, which includes various components operable, configured, or adapted to perform the method 1000. Communications device 1100 is described below in further detail.

Note that FIG. 10 is just one example of a method, and other methods including fewer, additional, or alternative steps are possible consistent with this disclosure.

### Example Communications Device(s)

FIG. 11 depicts aspects of an example communications device 1100. In some aspects, communications device 1100 is a user equipment, such as UE 104 described above with respect to FIGS. 1 and 3.

The communications device 1100 includes a processing system 1102 coupled to the transceiver 1138 (e.g., a transmitter and/or a receiver). The transceiver 1138 is configured to transmit and receive signals for the communications device 1100 via the antenna 1140, such as the various signals as described herein. The processing system 1102 may be configured to perform processing functions for the communications device 1100, including processing signals received and/or to be transmitted by the communications device 1100.

The processing system 1102 includes one or more processors 1104. In various aspects, the one or more processors 1104 may be representative of one or more of receive processor 358, transmit processor 364, TX MIMO processor 366, and/or controller/processor 380, as described with respect to FIG. 3. The one or more processors 1104 are coupled to a computer-readable medium/memory 1120 via a bus 1136. In certain aspects, the computer-readable medium/memory 1120 is configured to store instructions (e.g., computer-executable code) that when executed by the one or more processors 1104, cause the one or more processors 1104 to perform the method 1000 described with respect to FIG. 10, or any aspect related to it. Note that reference to a processor performing a function of communications device 1100 may include one or more processors 1104 performing that function of communications device 1100.

In the depicted example, computer-readable medium/memory 1120 stores code (e.g., executable instructions), such as code for collecting 1122, code for predicting 1124, code for preparing 1126, code for performing 1128, code for determining 1130, code for obtaining 1132, and code for estimating 1134. Processing of the code for collecting 1122, code for predicting 1124, code for preparing 1126, code for performing 1128, code for determining 1130, code for obtaining 1132, and code for estimating 1134 may cause the communications device 1100 to perform the method 1000 described with respect to FIG. 10, or any aspect related to it.

The one or more processors 1104 include circuitry configured to implement (e.g., execute) the code stored in the computer-readable medium/memory 1120, including circuitry such as circuitry for collecting 1106, circuitry for predicting 1108, circuitry for preparing 1110, circuitry for performing 1112, circuitry for determining 1114, circuitry for obtaining 1116, and circuitry for estimating 1118. Processing with circuitry for collecting 1106, circuitry for predicting 1108, circuitry for preparing 1110, circuitry for performing 1112, circuitry for determining 1114, circuitry for obtaining 1116, and circuitry for estimating 1118 may cause the communications device 1100 to perform the method 1000 described with respect to FIG. 10, or any aspect related to it.

Various components of the communications device 1100 may provide means for performing the method 1000 described with respect to FIG. 10, or any aspect related to it. For example, means for transmitting, sending or outputting for transmission may include transceivers 354 and/or antenna(s) 352 of the UE 104 illustrated in FIG. 3 and/or the transceiver 1138 and the antenna 1140 of the communications device 1100 in FIG. 11. Means for receiving or obtaining may include transceivers 354 and/or antenna(s) 352 of the UE 104 illustrated in FIG. 3 and/or the transceiver 1038 and the antenna 1040 of the communications device 1100 in FIG. 11.

### EXAMPLE CLAUSES

Implementation examples are described in the following numbered clauses:

Clause 1: A method for wireless communication by a user equipment (UE), comprising: collecting data using one or more sensors; predicting a future orientation and position of the UE based on the collected data; preparing a configuration of the UE for at least one of antenna switching or beam switching in response to the predicted future orientation and position of the UE; and performing the at least one of the antenna switching or beam switching, using the prepared configuration of the UE, in response to a detected current orientation and position of the UE.

Clause 2: The method of Clause 1, wherein the UE comprises an extended reality (XR) device.

Clause 3: The method of Clause 2, wherein the UE comprises an XR head mounted display, smart glasses, or other wearable XR device.

Clause 4: The method of any combination of Clauses 1-3, wherein the collecting the data using the one or more sensors comprises collecting head tracking data of a user associated with the UE.

Clause 5: The method of Clause 4, wherein the one or more sensors comprise at least one of an inertial measurement unit (IMU), an electromyogram (EMG), or a combination thereof.

Clause 6: The method of any combination of Clauses 4-5, wherein the predicting the future orientation and position of the UE based on the collected data comprises inputting the head tracking data of the user associated with the UE to a trained machine learning model to predict the future orientation and position of the UE.

Clause 7: The method of Clause 6, wherein the predicting the future orientation and position of the UE using the trained machine learning model comprises: setting one or more future times for orientation and position prediction for the machine learning model; optimizing an orientation and position prediction error limit, for the machine learning model, based on the one or more future times to generate a final machine learning model; and predicting the future orientation and position of the UE at the one or more future times using the final machine learning model.

Clause 8: The method of combination one of Clauses 1-7, further comprising determining a future time for which to predict the future orientation and position of the UE, wherein the determining the future time is based on a worst case duration for executing a beam switch or antenna switch.

Clause 9: The method of any combination of Clauses 1-8, wherein the preparing the configuration of the UE for the antenna switching in response to the predicted future orientation and position of the UE comprises: periodically determining the current orientation and position of the UE; identifying, based on the current orientation and position of the UE, one or more sectors served by each of one or more antennas of the UE; and in response to identifying the predicted future orientation of the UE falls within a different sector than the one or more sectors, preparing a radio frequency (RF) tune script for the antenna switching.

Clause 10: The method of Clause 9, wherein performing the antenna switching comprises executing the RF tune script for the antenna switching.

Clause 11: The method of any combination of Clauses 1-10, wherein the preparing the configuration of the UE for the antenna switching in response to the predicted future orientation and position of the UE comprises preparing for antenna switch diversity (ASDIV) switching based on the predicted future orientation of the UE.

Clause 12: The method of any combination of Clauses 1-11, further comprising obtaining a plurality of predefined antenna switching configurations associated with a plurality of UE orientations and positions, wherein the preparing for the antenna switching in response to the predicted future orientation and position of the UE comprises preparing one of the plurality of predefined antenna switching configurations associated the predicted UE orientation and position.

Clause 13: The method of any combination of Clauses 1-12, wherein the preparing the configuration of the UE for the antenna switching in response to the predicted future orientation and position of the UE comprises preparing for the antenna switching before a measured signal quality meets an antenna switching trigger threshold.

Clause 14: The method of combination one of Clauses 1-13, further comprising estimating an initial transmit power of the UE associated with prepared antenna switching, wherein the estimating the initial transmit power of the UE is before the performing the antenna switching.

Clause 15: The method of Clause 14, wherein the estimating the initial transmit power of the UE based on the predicted future orientation of the UE comprises estimating the initial transmit power of the UE based on historical data of previous transmissions by the UE with the predicted orientation and position of the UE.

Clause 16: The method of any combination of Clauses 1-15, wherein the preparing the configuration of the UE for the beam switching in response to the predicted future orientation and position of the UE comprises: periodically determining the current orientation and position of the UE; identifying, based on the current orientation and position of the UE, one or more sectors served by each of one or more antennas of the UE; and in response to identifying the predicted future orientation of the UE falls within a different sector than the one or more sectors, preparing a radio frequency (RF) tune script for the beam switching.

Clause 17: The method of Clause 16, wherein performing the beam switching comprises executing the RF tune scrip for the beam switching in response to a measured signal quality of candidate beam satisfying the beam switching threshold.

Clause 18: The method of any combination of Clauses 1-17, further comprising obtaining a plurality of predefined beam switching configurations associated with a plurality of UE orientations and positions, wherein the preparing for the beam switching in response to the predicted future orientation and position of the UE comprises preparing one of the plurality of predefined beam switching configurations associated the predicted UE orientation and position.

Clause 19: The method of any combination of Clauses 1-18, wherein the preparing the configuration of the UE for the beam switching in response to the predicted future orientation and position of the UE comprises: predicting a set of future candidate beams based on the predicted future orientation and position of the UE; and prioritizing measurements on the predicted set of future candidate beams.

Clause 20: An apparatus, comprising: at least one memory comprising executable instructions; and at least one processor configured to execute the executable instructions and cause the apparatus to perform a method in accordance with any combination of Clauses 1-19.

Clause 21: An apparatus, comprising means for performing a method in accordance with any combination of Clauses 1-19.

Clause 22: A non-transitory computer-readable medium comprising executable instructions that, when executed by at least one processor of an apparatus, cause the apparatus to perform a method in accordance with any combination of Clauses 1-19.

Clause 23: A computer program product embodied on a computer-readable storage medium comprising code for performing a method in accordance with any combination of Clauses 1-19.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a graphics processing unit (GPU), a neural processing unit (NPU), a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

Means for collecting, means for predicting, means for preparing, means for performing, means for determining, means for obtaining, and means for estimating may comprise one or more processors, such as one or more of the processors described above with reference to FIG. 11.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication, the apparatus comprising:
memory storing computer executable code; and
one or more processors configured to execute the computer executable code and cause the apparatus to:
collect data using one or more sensors;
predict a future orientation and position of the apparatus based on the collected data;
prepare a configuration of the apparatus for at least one of antenna switching or beam switching in response to the predicted future orientation and position of the apparatus; and
perform the at least one of the antenna switching or beam switching, using the prepared configuration of the apparatus, in response to a detected current orientation and position of the apparatus.

2. The apparatus of claim 1, wherein the apparatus comprises an XR head mounted display, smart glasses, or other wearable XR device.

3. The apparatus of claim 1, wherein the one or more processors are configured to cause the apparatus to collect head tracking data of a user associated with the apparatus.

4. The apparatus of claim 3, wherein the one or more sensors comprise at least one of an inertial measurement unit (IMU), an electromyogram (EMG), or a combination thereof.

5. The apparatus of claim 3, wherein the one or more processors are configured to cause the apparatus to input the head tracking data of the user associated with the apparatus to a trained machine learning model to predict the future orientation and position of the apparatus.

6. The apparatus of claim 5, wherein the one or more processors are configured to cause the apparatus to:
set one or more future times for orientation and position prediction for the machine learning model;
optimize an orientation and position prediction error limit, for the machine learning model, based on the one or more future times to generate a final machine learning model; and
predict the future orientation and position of the apparatus at the one or more future times using the final machine learning model.

7. The apparatus of claim 1, in the one or more processors are configured to cause the apparatus to determine a future time for which to predict the future orientation and position of the apparatus, wherein the determination of the future time is based on a worst case duration for executing a beam switch or antenna switch.

8. The apparatus of claim 1, wherein the one or more processors are configured to cause the apparatus to:
periodically determine the current orientation and position of the apparatus;
identify, based on the current orientation and position of the apparatus, one or more sectors served by each of one or more antennas of the apparatus; and
in response to the identification of the predicted future orientation of the apparatus falls within a different sector than the one or more sectors, prepare a radio frequency (RF) tune script for the antenna switching.

9. The apparatus of claim 8, wherein the one or more processors are configured to cause the apparatus to execute the RF tune script for the antenna switching.

10. The apparatus of claim 1, wherein the one or more processors are configured to cause the apparatus to prepare for antenna switch diversity (ASDIV) switching based on the predicted future orientation of the apparatus.

11. The apparatus of claim 1, wherein the one or more processors are configured to cause the apparatus to:
obtain a plurality of predefined antenna switching configurations associated with a plurality of apparatus orientations and positions; and
prepare one of the plurality of predefined antenna switching configurations associated the predicted apparatus orientation and position.

12. The apparatus of claim 1, wherein the one or more processors are configured to cause the apparatus to prepare for the antenna switching before a measured signal quality meets an antenna switching trigger threshold.

13. The apparatus of claim 1, wherein the one or more processors are configured to cause the apparatus to estimate an initial transmit power of the apparatus associated with prepared antenna switching, wherein the estimation of the initial transmit power of the apparatus is before the performance of the antenna switching.

14. The apparatus of claim 13, wherein the one or more processors are configured to cause the apparatus to estimate the initial transmit power of the apparatus based on historical data of previous transmissions by the apparatus with the predicted orientation and position of the apparatus.

15. The apparatus of claim 1, wherein the one or more processors are configured to cause the apparatus to:
periodically determine the current orientation and position of the apparatus;
identify, based on the current orientation and position of the apparatus, one or more sectors served by each of one or more antennas of the apparatus; and
in response to identification of the predicted future orientation of the apparatus falls within a different sector than the one or more sectors, prepare a radio frequency (RF) tune script for the beam switching.

16. The apparatus of claim 15, wherein the one or more processors are configured to cause the apparatus to execute the RF tune scrip for the beam switching in response to a measured signal quality of candidate beam satisfying the beam switching threshold.

17. The apparatus of claim 1, wherein the one or more processors are configured to cause the apparatus to:
obtain a plurality of predefined beam switching configurations associated with a plurality of apparatus orientations and positions; and
prepare one of the plurality of predefined beam switching configurations associated the predicted apparatus orientation and position.

18. The apparatus of claim 1, wherein the one or more processors are configured to cause the apparatus to:
predict a set of future candidate beams based on the predicted future orientation and position of the apparatus; and
prioritize measurements on the predicted set of future candidate beams.

19. A method for wireless communication by a user equipment (UE), the method comprising:
collecting data using one or more sensors;
predicting a future orientation and position of the UE based on the collected data;
preparing a configuration of the UE for at least one of antenna switching or beam switching in response to the predicted future orientation and position of the UE; and
performing the at least one of the antenna switching or beam switching, using the prepared configuration of the UE, in response to a detected current orientation and position of the UE.

20. A computer readable medium storing computer executable code for wireless communication by a user equipment (UE), the computer executable code comprising:
code for collecting data using one or more sensors;
code for predicting a future orientation and position of the UE based on the collected data;
code for preparing a configuration of the UE for at least one of antenna switching or beam switching in response to the predicted future orientation and position of the UE; and
code for performing the at least one of the antenna switching or beam switching, using the prepared configuration of the UE, in response to a detected current orientation and position of the UE.
